(19) United States
(12) Patent Application Publication
(10) Pub. No.: US 2004/0231451 A1
(43) Pub. Date: Nov. 25, 2004

(54) Handlebar structure of bicycle

(76) Inventors: Cheng-Hsun Chiang, Taichung Hsien (TW); David Michael Anthony, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/440,860

(22) Filed: May 19, 2003

(51) Int. Cl. B62K 21/12

(52) U.S. Cl. 74/551.1

(57) ABSTRACT

A handlebar structure includes a handlebar body having two end portions each provided with a first face having an arcuate convex shape and a second face formed with a recess. Thus, the arcuate convex configuration of the first face of the handlebar body satisfies the ergonomic design, so that when the user's hand holds the handlebar body, the first face of the handlebar body provides a comfortable sensation to the user's hand, thereby facilitating the user's hand holding the handlebar body.

### BACKGROUND OF THE INVENTION

1. Field of the Invention

The present invention relates to a handlebar structure, and more particularly to a handlebar structure of a bicycle.

2. Description of the Related Art

A conventional handlebar 20 of a bicycle in accordance with the prior art shown in FIG. 8 has two end portions each bent forward and extended downward. Thus, the conventional handlebar 20 presents a flat shape, and has a constant diameter. However, the handlebar 20 having a constant diameter does not satisfy the ergonomic design, so that when the user's hands hold the handlebar, the user's hands easily feels uncomfortable when holding the handlebar. In addition, the handlebar 20 having a constant diameter does not fit the hands of users of different sizes, so that the handlebar 20 cannot satisfy the user's practical requirements.

### SUMMARY OF THE INVENTION

The primary objective of the present invention is to provide a handlebar structure, wherein the arcuate convex configuration of the first face of the handlebar body satisfies the ergonomic design, so that when the user's hand holds the handlebar body, the first face of the handlebar body provides a comfortable sensation to the user's hand, thereby facilitating the user's hand holding the handlebar body.

Another objective of the present invention is to provide a handlebar structure, wherein the thickness of the first face of the handlebar body is gradually reduced from the mediate portion toward the two ends thereof, so that the handlebar body can fit the hands of users of different sizes, thereby satisfying the user's practical requirements.

A further objective of the present invention is to provide a handlebar structure, wherein by the arcuate convex configuration of the first face of the handlebar body, the holding positions of the user's hand can be arbitrarily adjusted easily and conveniently, without having to adjust the position of the user's upper body, thereby facilitating the user adjusting the holding positions of the handlebar body.

A further objective of the present invention is to provide a handlebar structure, wherein the arcuate concave portions of the two end portions of the handlebar body are designed to fit the user's hands to provide a comfortable sensation to the user's hands, thereby facilitating the user's hands holding the handlebar body.

A further objective of the present invention is to provide a handlebar structure, wherein the anti-skid flange of each of the two end portions of the handlebar body has an arcuate convex shape to provide an anti-skid effect to the user's hand and to provide a comfortable sensation to the user's hand, thereby facilitating the user's hands holding the handlebar body.

A further objective of the present invention is to provide a handlebar structure, wherein the second face of the handlebar body has a mediate portion formed with a recess, so that when the user's hand holds the handlebar body, the ball of the user's thumb is received in the recess, to provide a comfortable sensation to the user's hand, thereby facilitating the user's hands holding the handlebar body.

In accordance with the present invention, there is provided a handlebar structure, comprising:

a handlebar body having two end portions each provided with a first face and a second face;

the first face of the handlebar body having an arcuate convex configuration; and

the second face of the handlebar body is formed with a recess.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a handlebar structure in accordance with the preferred embodiment of the present invention;

FIG. 2 is a top plan operational view of the handlebar structure as shown in FIG. 1;

FIG. 3 is a top plan operational view of the handlebar structure as shown in FIG. 1;

FIG. 4 is a partially cut-away plan view of the handlebar structure as shown in FIG. 3;

FIG. 5 is a top plan view of the handlebar structure as shown in FIG. 1;

FIG. 6 is a plan cross-sectional view of the handlebar structure taken along line 6-6 as shown in FIG. 5;

FIG. 7 is a perspective view of the handlebar structure for a bicycle in accordance with the preferred embodiment of the present invention; and

FIG. 8 is a perspective view of a conventional handlebar of a bicycle in accordance with the prior art.

### DETAILED DESCRIPTION OF THE INVENTION

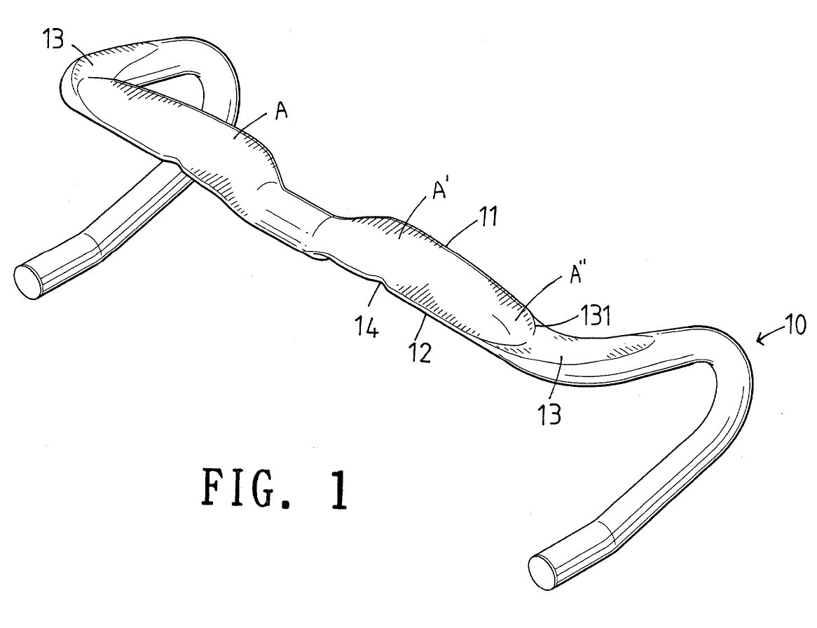

Referring to the drawings and initially to FIGS. 1-6, a handlebar structure of a bicycle in accordance with the preferred embodiment of the present invention comprises a handlebar body 10 having two end portions each provided with a first face 11 and a second face 12. Preferably, the handlebar body 10 is made of composite material.

The first face 11 of the handlebar body 10 has an arcuate convex configuration. The first face 11 of the handlebar body 10 protrudes outward and has a thickness gradually reduced from the mediate portion toward the two ends thereof.

Each of the two end portions of the handlebar body 10 has a bent portion formed with an arcuate concave portion 13. The arcuate concave portion 13 of each of the two end portions of the handlebar body 10 has an end formed with an anti-skid flange 131. The anti-skid flange 131 of each of the two end portions of the handlebar body 10 has an arcuate convex shape.

The second face 12 of the handlebar body 10 is substantially flat-shaped, and has a mediate portion formed with a recess 14.

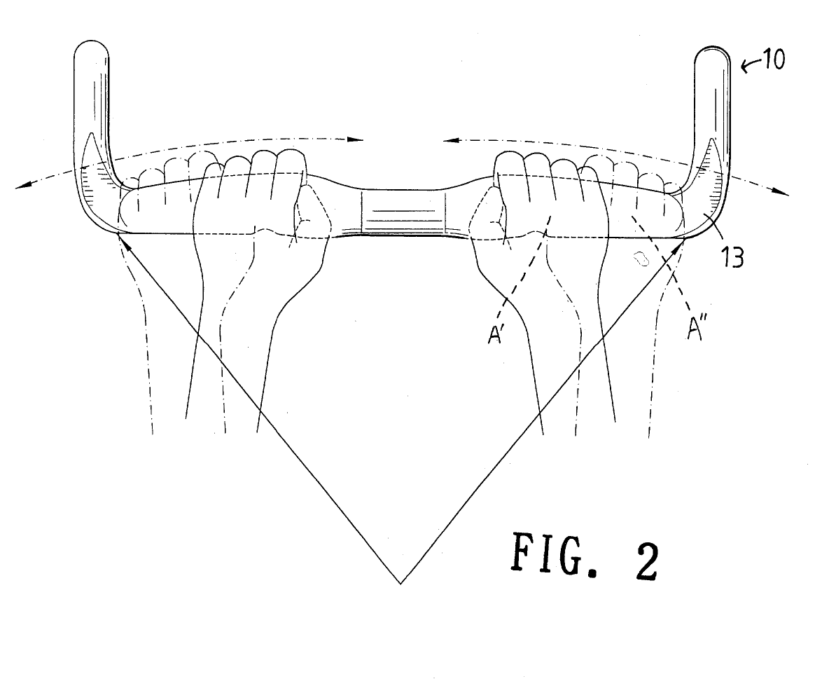

In use, the user's hand holds the holding portion A of the handlebar body 10. In such a manner, the arcuate convex configuration of the first face 11 of the handlebar body 10 satisfies the ergonomic design, so that when the user's hand is moved from the position A′ to the position A″ as shown in FIG. 2, the first face 11 of the handlebar body 10 provides a comfortable sensation to the user's hand, thereby facilitating the user's hand holding the handlebar body 10. In addition, the thickness of the first face 11 of the handlebar body 10 is gradually reduced from the mediate portion toward the two ends thereof, so that the handlebar body 10 can fit the hands of users of different sizes, thereby satisfying the user's practical requirements. Further, by the arcuate convex configuration of the first face 11 of the handlebar body 10, the holding positions of the user's hand can be arbitrarily adjusted easily and conveniently, without having to adjust the position of the user's upper body, thereby facilitating the user adjusting the holding positions of the handlebar body 10.

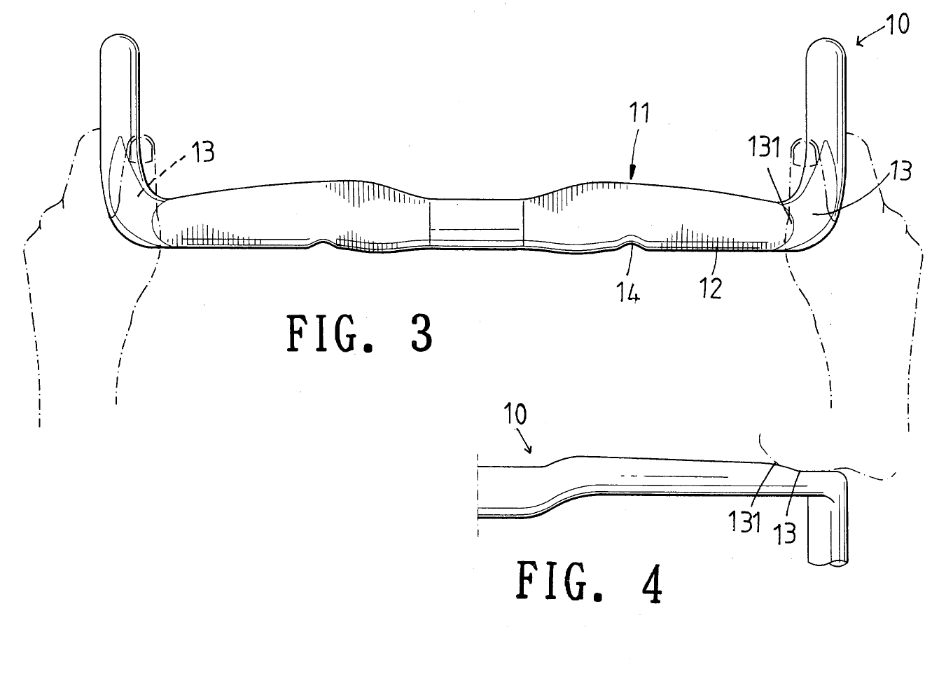

As shown in FIGS. 3 and 4, the user's hands hold the arcuate concave portions 13 of the two end portions of the handlebar body 10. In such a manner, the arcuate concave portions 13 of the two end portions of the handlebar body 10 are designed to fit the user's hands, so as to provide a comfortable sensation to the user's hands, thereby facilitating the user's hands holding the handlebar body 10. In addition, the anti-skid flange 131 of each of the two end portions of the handlebar body 10 has an arcuate convex shape to provide an anti-skid effect to the user's hand and to provide a comfortable sensation to the user's hand, thereby facilitating the user's hands holding the handlebar body 10.

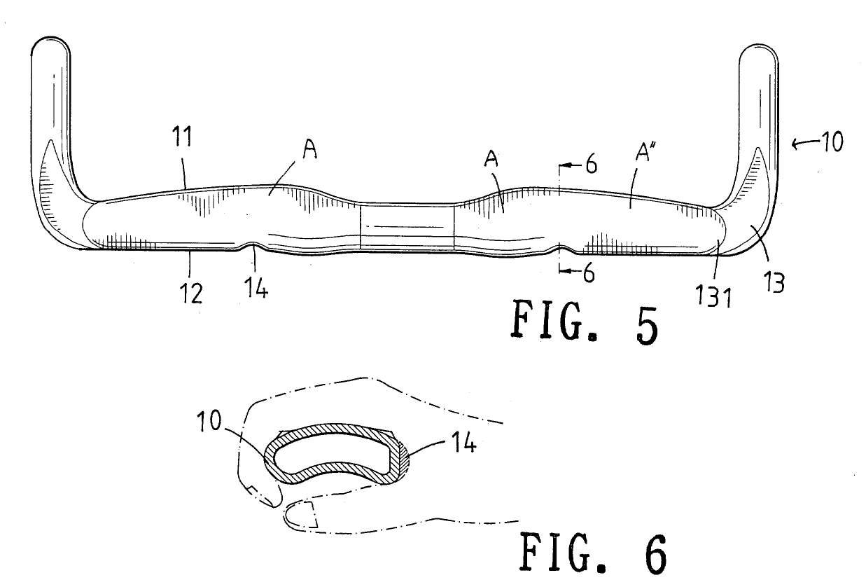

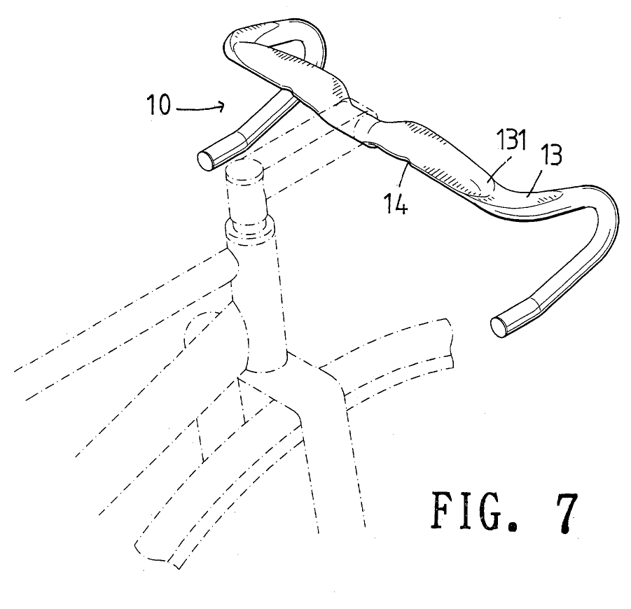

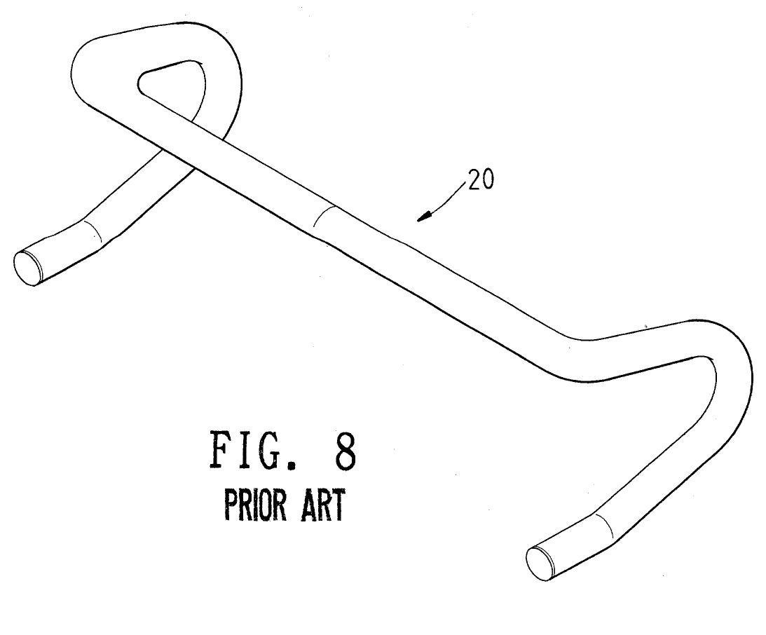

As shown in FIGS. 5 and 6, the second face 12 of the handlebar body 10 has a mediate portion formed with a recess 14. Thus, when the user's hand holds the holding portion A of the handlebar body 10, the ball of the user's thumb is received in the recess 14, to provide a comfortable sensation to the user's hand, thereby facilitating the user's hands holding the handlebar body 10.

As shown in FIG. 7, the handlebar body 10 is mounted on a bicycle for use.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A handlebar structure, comprising:
a handlebar body having two end portions each provided with a first face and a second face;
the first face of the handlebar body having an arcuate convex configuration; and
the second face of the handlebar body is formed with a recess.

2. The handlebar structure in accordance with claim 1, wherein the handlebar body is made of composite material.

3. The handlebar structure in accordance with claim 1, wherein the first face of the handlebar body protrudes outward.

4. The handlebar structure in accordance with claim 1, wherein the first face of the handlebar body has a thickness gradually reduced from the mediate portion toward the two ends thereof.

5. The handlebar structure in accordance with claim 1, wherein the each of the two end portions of the handlebar body has a bent portion formed with an arcuate concave portion.

6. The handlebar structure in accordance with claim 5, wherein the arcuate concave portion of each of the two end portions of the handlebar body has an end formed with an anti-skid flange.

7. The handlebar structure in accordance with claim 6, wherein the anti-skid flange of each of the two end portions of the handlebar body has an arcuate convex shape.

8. The handlebar structure in accordance with claim 1, wherein the second face of the handlebar body is substantially flat-shaped.

9. The handlebar structure in accordance with claim 1, wherein the second face of the handlebar body has a mediate portion formed with the recess.
